(19) United States
(12) Patent Application Publication
(10) Pub. No.: US 2004/0139473 A1
(43) Pub. Date: Jul. 15, 2004

(54) Increasing capacity in a cable modem termination system (CMTS) with passive redundancy

(75) Inventor: Clarke V. Greene, Middletown, CT (US)

Correspondence Address: Fogg and Associates, LLC, P.O. Box 581339, Minneapolis, MN, 55458-1339, US

(73) Assignee: ADC Broadband Access Systems, Inc.

(21) Appl. No.: 10/339,983

(22) Filed: Jan. 10, 2003

(51) Int. Cl. H04N 7/173; H04L 1/22; H04L 5/22; H04L 5/14; H04B 1/56; H03K 19/003; H05K 10/00; H02H 3/05; H04B 1/74; H04L 27/04; H03C 1/52

(52) U.S. Cl. 725/111; 725/95; 370/275; 370/299; 714/6; 714/7; 714/13

(57) ABSTRACT

A method for adjusting bandwidth allocation in a cable modem termination system is provided. The method includes detecting an overflow condition at a primary transceiver of the cable modem termination system, determining whether a back-up transceiver is available in the cable modem termination system, and when the back-up transceiver is available, establishing at least one channel for the back-up transceiver to communicate over a common physical medium with at least one channel of the primary transceiver to effectively increase the bandwidth of the cable modem termination system.

### CROSS REFERENCE TO RELATED APPLICATIONS

This application is related to U.S. patent application Ser. No. 09/995,167 entitled PASSIVE CMTS REDUNDANCY, filed Nov. 26, 2001 (the '167 Application). The '167 Application is incorporated herein by reference.

### TECHNICAL FIELD

The present invention relates generally to telecommunications, and in particular to backup for cable modem termination systems (CMTS).

### BACKGROUND

Coaxial cable networks have been used to deliver high quality video programming to subscribers for many years. Conventionally, these networks have been unidirectional, broadcast networks with a limited number of channels and a limited variety of content provided to the subscribers. In recent years, cable companies have developed systems to provide bi-directional communication over their existing networks to provide a wider variety of services and content to their subscribers. For example, many cable companies now provide connection to the Internet through the use of cable modems.

The cable industry has developed a number of standards for delivering data over their networks to provide a uniform basis for the design and development of the equipment necessary to support these services. For example, a consortium of cable companies developed the Data Over Cable Service Interface Specifications (DOCSIS) standard. The DOCSIS standard specifies the necessary interfaces to allow for transparent, bi-directional transfer of Internet Protocol (IP) traffic between a cable head end and customer equipment over a cable network, such as a coaxial cable network or hybrid fiber/coax (HFC) network.

A cable modem termination system (CMTS) is included in the head end of the cable network for processing the upstream and downstream transmission of data. In the upstream, the CMTS down converts data signals from cable modems to base band or a low intermediate frequency. The CMTS then demodulates the signals and provides the data to a network, e.g., the Internet. In the downstream, the CMTS receives data for a plurality of modems at a network interface. The CMTS modulates a carrier with this data and transmits it downstream over a shared medium to the plurality of modems.

Problems frequently occur during high usage times when the amount of data received and/or transmitted by a CMTS reaches capacity limits of the CMTS. Such problems often include reduced data flow rates, data contention, etc. Moreover, users can even be denied access during high usage times.

For the reasons stated above, and for other reasons stated below that will become apparent to those skilled in the art upon reading and understanding the present specification, there is a need in the art for increasing capacity of cable modem termination systems.

### SUMMARY

The above-mentioned problems with cable modem termination systems and other problems are addressed by embodiments of the present invention and will be understood by reading and studying the following specification. In one embodiment, the capacity of the cable modem termination system is increased on an as-needed basis by using bandwidth of a backup transceiver when not in use carrying signals for a failed primary transceiver. Thus, the capacity of the system is intermittently increased to meet demand without requiring dedication of an additional transceiver and still providing the backup function.

In one embodiment, a method for adjusting bandwidth allocation in a cable modem termination system is provided. The method includes detecting an overflow condition at a primary transceiver of the cable modem termination system, determining whether a back-up transceiver is available in the cable modem termination system, and when the back-up transceiver is available, establishing at least one channel for the back-up transceiver to communicate over a common physical medium with at least one channel of the primary transceiver to effectively increase the bandwidth of the cable modem termination system.

Further embodiments of the invention include apparatus and methods of varying scope.

### BRIEF DESCRIPTION OF THE DRAWINGS

FIG. 1 is a schematic of a communications network in accordance with an embodiment of the invention.

FIG. 2 is a schematic of a cable modem termination system (CMTS) in accordance with an embodiment of the invention.

FIG. 3 is a schematic showing detail of a primary CMTS transceiver and an associated interface adapter in accordance with an embodiment of the invention.

FIGS. 4A-4B are schematics of an upstream switch module including optional directional couplers and pilot tone generator for use in testing of the CMTS in accordance with an embodiment of the invention.

FIGS. 5A-5B are schematics of a downstream switch module including optional directional couplers and RF level detector for use in testing of the CMTS in accordance with an embodiment of the invention.

FIG. 6 is a block diagram of a CMTS showing connectivity of various components in accordance with an embodiment of the invention.

FIG. 7 is a flow chart of a process for operating a CMTS in an overflow mode according to an embodiment of the invention.

### DETAILED DESCRIPTION

In the following detailed description of the present embodiments, reference is made the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

The various embodiments provide passive backup for cable modem termination systems (CMTS). Passive backup allows a backup transceiver to be activated to handle overflow data traffic, as needed. The various embodiments further facilitate elimination of the use of switches or any active components in the primary signal path that can reduce the reliability of the system.

Various embodiments utilize directional couplers in the primary signal path for each CMTS transceiver to be backed up. Signals sent between subscriber equipment and the primary CMTS transceivers pass through directional couplers with relatively low loss. Signals associated with data overflow are selectively routed through a backup CMTS transceiver outside of the primary signal path.

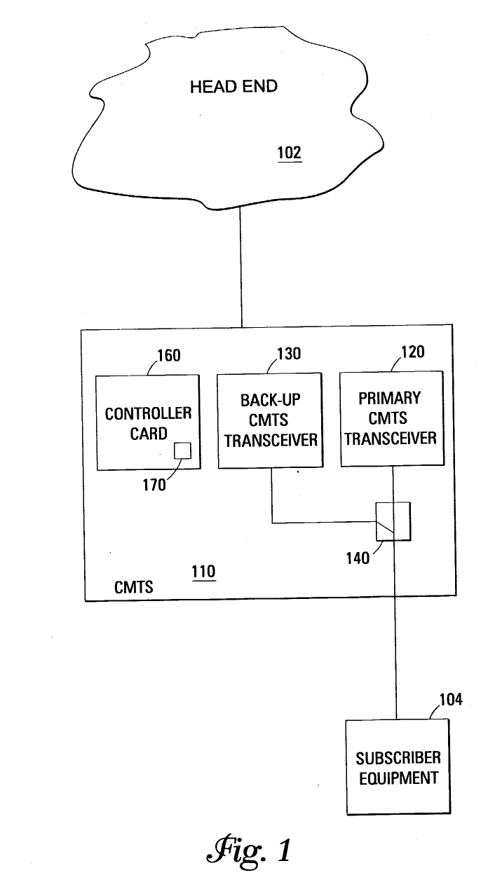

FIG. 1 is a schematic of a communications network 100 in accordance with an embodiment of the invention. The communications network 100 carries communication signals between a head end 102, e.g., the Internet, and subscriber equipment 104, e.g., cable modems, through an access network 106, e.g., a coaxial cable network or hybrid fiber/coax (HFC) network using the Data Over Cable Service Interface Specifications (DOCSIS) standard.

Communication signals between the head end 102 and the subscriber equipment 104 is facilitated through a cable modem termination system (CMTS) 110 connected between the access network 106 and the head end 102. As used herein, the term “connected” in its various forms refers to establishing an ability to convey communication signals and does not require a direct physical or electrical connection.

The CMTS 110 includes at least one primary CMTS transceiver 120 and at least one backup CMTS transceiver 130. While the ratio of primary CMTS transceivers 120 to backup CMTS transceivers 130 is not limited by the invention, it is typically preferred to have some ratio greater than one. For one embodiment, there is one backup CMTS transceiver 130 for every six primary CMTS transceivers 120. For another embodiment, there is one backup CMTS transceiver 130 for every ten primary CMTS transceivers 120.

Passive directional couplers 140 are connected between the access network 106 and the primary CMTS transceivers. In a similar fashion, further directional couplers (not shown in FIG. 1 for clarity) are connected between the head end 102 and the primary CMTS transceivers 120. The directional couplers 140 are configured to incur relatively low loss in the primary signal path, i.e., the path between the head end 102 and the subscriber equipment 104 through the primary CMTS transceivers 120, yet permit a portion of the signal to pass to the backup CMTS transceiver 130. The use of passive devices such as the directional couplers 140 permit switching to the backup CMTS transceiver 130 without having an active switching device in the primary signal path.

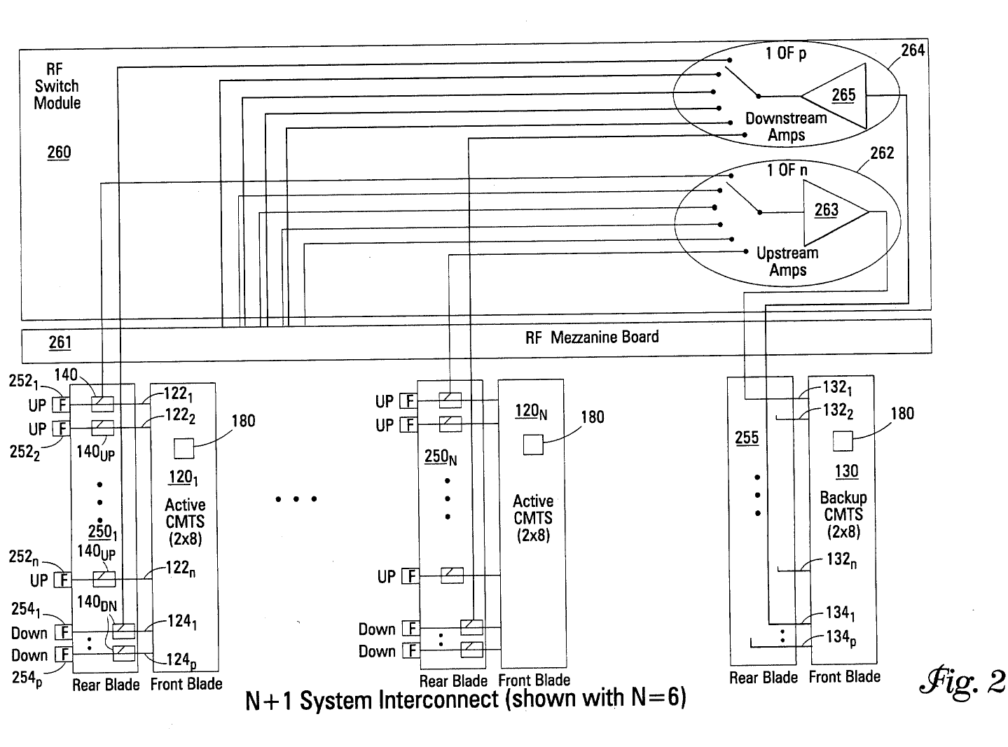

FIG. 2 is a schematic of a CMTS 110 in accordance with an embodiment of the invention. The CMTS 110 includes a plurality of active or primary CMTS transceivers 120₁ to 120_{N} for every one backup CMTS transceiver 130. Each of primary CMTS transceivers 120₁ to 120_{N} has a number of communication ports. Similarly, each backup CMTS transceiver 130 has a number of communication ports. As used herein, communication ports for connecting to the subscriber equipment 104 will be termed upstream communication ports and communication ports for connecting to the head end 102 will be termed downstream communication ports.

Upstream communication ports for primary CMTS transceivers are designated as reference numbers 122₁ to 122ₙ in FIG. 2 while upstream communication ports for backup CMTS transceivers are designated as reference numbers 132₁ to 132ₙ in FIG. 2. Similarly, downstream communication ports for primary CMTS transceivers are designated as reference numbers 124₁ to 124_{P} in FIG. 2 while downstream communication ports for backup CMTS transceivers are designated as reference numbers 134₁ to 134_{P} in FIG. 2.

In general, each CMTS transceiver has one or more upstream communication ports and one or more downstream communication ports. A CMTS transceiver will typically have more upstream communication ports than downstream communication ports. However, such is not required. For one embodiment, each CMTS transceiver has eight upstream communication ports and two downstream communication ports. For ease of implementation and inventory, it is preferable that backup CMTS transceivers are either similarly configured, containing a corresponding communication port for each communication port of the primary CMTS transceivers for which it provides redundancy, or they contain at least as many downstream and upstream ports as any primary CMTS in the system.

Each of primary CMTS transceivers 120₁ to 120_{N} is respectively connected to interface adapters 250₁ to 250_{N}. Each of interface adapters 250₁ to 250 _{N} includes upstream communication ports 252₁ to 252ₙ and downstream communication ports 254₁ to 254_{P}. A directional coupler 140ᵤₚ is connected between each of upstream communication ports 252₁ to 252ₙ and upstream communications ports 122₁ to 122ₙ, as illustrated for CMTS transceiver 120₁ and interface adapter 250₁. A directional coupler 140_{DN} is connected between each of downstream communication ports 254₁, to 254_{P} and downstream communications ports 124₁ to 124_{P}, as illustrated for CMTS transceiver 120₁ and interface adapter 250₁.

Each directional coupler 140 is further connected to a switch module 260. Such connection may be made through an optional intermediary device, designated in FIG. 2 as mezzanine board 261. The switch module 260 acts as a multiplexer, selectively connecting a directional coupler 140 with an associated communication port of the backup CMTS transceiver 130.

For one embodiment, the switch module 260 includes one upstream switching module 262 for each of upstream communications ports 132₁ to 132ₙ of backup CMTS transceiver 130. Each upstream switching module 262 selectively connects one of upstream communications ports 132₁ to 132ₙ, e.g., upstream communications port 132₁, to the respective one of upstream communications ports 252₁ to 252ₙ, e.g., upstream communications port 252₁, of each of interface adapters 250₁ to 250_{N} via the corresponding directional coupler 140_{UP}.

For a further embodiment, the switch module 260 further includes one downstream switching module 264 for each of downstream communications ports 134₁ to 134_{P} of backup CMTS transceiver 130. Each downstream switching module 264 selectively connects one of downstream communications ports 134₁ to 134_{P}, e.g., downstream communications port 134₁, to the respective one of downstream communications ports 254₁ to 254_{P}, e.g., downstream communications port 254₁, of each of interface adapters 250₁ to 250_{N} via the corresponding directional coupler 140_{DN}.

To maintain near unity gain when using the backup CMTS transceiver 130, the signal path between the backup CMTS transceiver 130 and the directional couplers 140 will need to be amplified. Because the directional couplers 140 are configured to have relatively low losses in the primary signal path, preferably on the order of 1.5 dB or less, losses between the backup CMTS transceiver 130 and the directional couplers 140 will generally be relatively high, e.g., 7 dB or more. Thus, to insure transparency to the end users when a switch is made to the backup CMTS transceiver 130 or when the backup CMTS transceiver is used to increase the bandwidth of the CMTS in an “overflow” mode as described below, this signal path must compensate for such losses. For one embodiment, an amplifier 263 is connected between each upstream switching module 262 and its associated upstream communication port 132. For a further embodiment, an amplifier 265 is connected between each downstream switching module 264 and its associated downstream communication port 134. While the amplifiers 262 and 264 could be connected on the opposite sides of the switching modules 262 and 264, respectively, it is more economical to have a one-to-one relationship with the communication ports of the backup CMTS transceiver 130 than with all of the primary CMTS transceivers 120.

The backup CMTS transceiver 130 may be connected to the switch modules 262/264 through an interface adapter 255. Although the interface adapter 255 could have the same configuration as the interface adapters 250, there is no need for additional directional couplers connected to the backup CMTS transceiver 130 through the interface adapter 255.

The inherent isolation between ports of the directional couplers 140 in the primary CMTS transceiver signal paths adds to the performance of the CMTS 110. Potential crosstalk between primary CMTS transceivers 120 through imperfections of the switching modules 262/264 is minimized. Additionally, when a primary CMTS transceiver 120 is removed for maintenance, the effect on the system performance when the backup CMTS transceiver 130 is active is negligible.

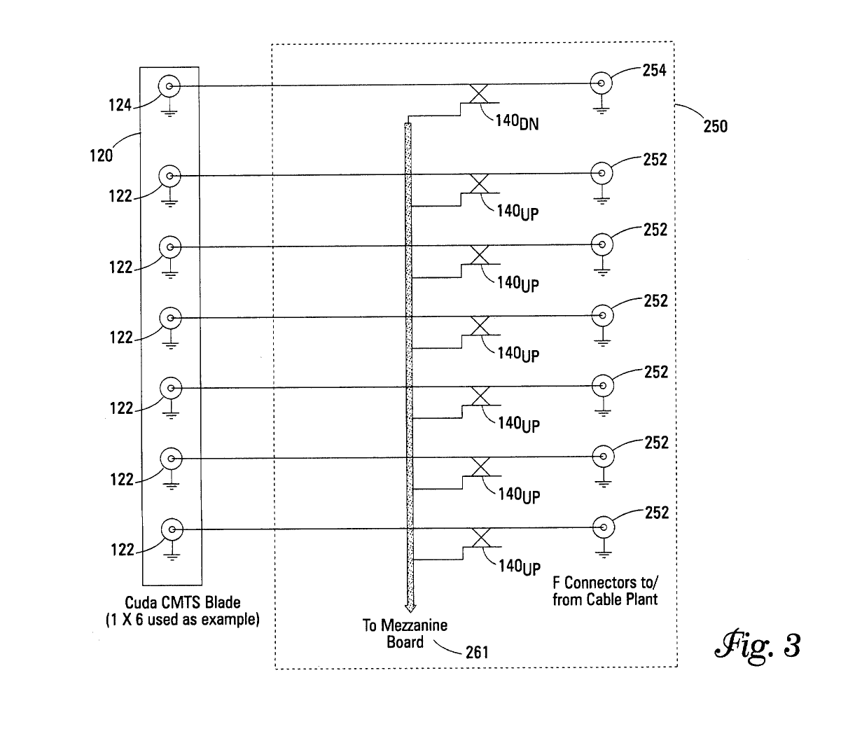

FIG. 3 is a schematic showing additional detail of a primary CMTS transceiver 120 and its associated interface adapter 250. The primary CMTS transceiver 120 depicted in FIG. 3 includes one downstream communication port 124 connected to a downsteam communication port 254 through a directional coupler 140_{DN}. Primary CMTS transceiver 120 also includes six upstream communication ports 122 respectively connected to six upstream communications ports 252 through six directional couplers 140_{UP}. For one embodiment, the directional couplers exhibit −1.5 dB in the downstream direction and −1.5 dB in the upstream direction for the primary signal path. For a further embodiment, the directional couplers exhibit −10 dB in the downstream direction and −10 dB in the upstream direction for the backup signal path, i.e., the path between the directional couplers 140 and the backup CMTS transceiver 130. Directional couplers 140 are generally 4-port devices. These ports are commonly referred to as an “in” port, an “out” port, a “forward coupled” port and a “reverse coupled” port. A signal in the primary signal path passes from the “in” port to the “out” port with relatively low loss. A signal in the backup signal path passes from the “in” port to the “forward coupled” port attenuated by the coupling value of the directional coupler. The unconnected port of each directional coupler 140, i.e., the “reverse coupled” port, is preferably resistance terminated. For one embodiment, a 75 ohm resistance is used to terminate each unconnected port.

Testing of the backup CMTS transceiver 130 is also possible with this scheme without interrupting primary CMTS service and without removing the backup CMTS transceiver 130 from the CMTS 110. Through the use of additional directional couplers in the backup signal path (not shown in FIGS. 2 or 3), internally generated test signals can be detected and measured. By exercising the switch modules 262/264, the service availability of the switches can be determined by detecting the test signals. This process in non-invasive to the primary CMTS transceiver signal paths.

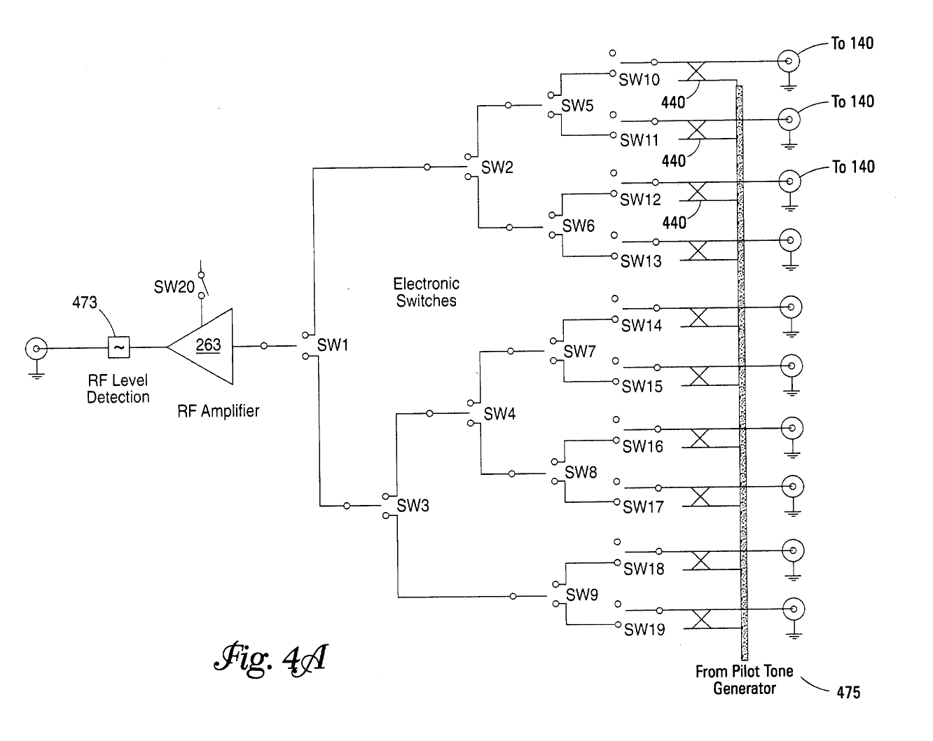

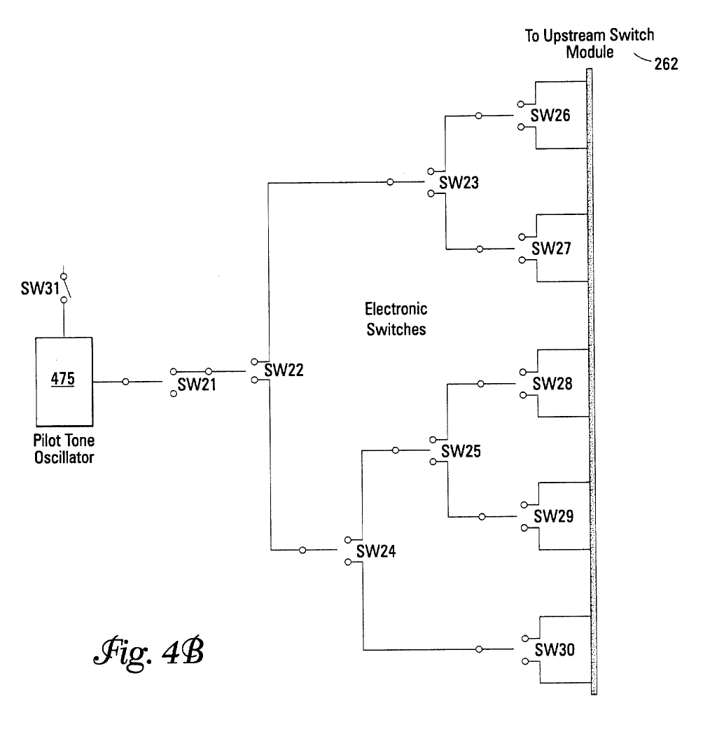

FIGS. 4A-4B are schematics of an upstream switch module 262 including optional directional couplers 440 and pilot tone generator 475 for use in testing of the CMTS 110. The upstream switch module 262 may further include circuitry 473 for detecting the RF level of the backup signal path. Such can be used to assure that the RF level is within operating limits when the intended switches are activated.

The upstream switching module 262 includes a plurality of switches, or switching matrix, SW1-SW19 of FIG. 4A for selectively connecting an upstream communication port of the backup CMTS transceiver 130 to its associated directional coupler 140 through a directional coupler 440. Switches SW1-SW19 of FIG. 4A are preferably RF switches or relays. An additional port of each directional coupler 440 is selectively connected to pilot tone generator 475, such as through electronic switches SW21-SW30 of FIG. 4B. The unconnected port of each directional coupler 440 is preferably resistance terminated.

The pilot tone generator 475 may be selectively activated, such as through switch SW31. Similarly, as the amplifier 263 is not needed unless the backup CMTS transceiver 130 is active, it may be selectively activated, such as through switch SW20. The pilot tone generator 475 permits testing of the receive portion of the backup CMTS transceiver 130, as well as the switches and amplifier that pass the upstream signals to the backup CMTS transceiver 130. For one embodiment, the pilot tone generator 275 resides in the backup CMTS transceiver 130.

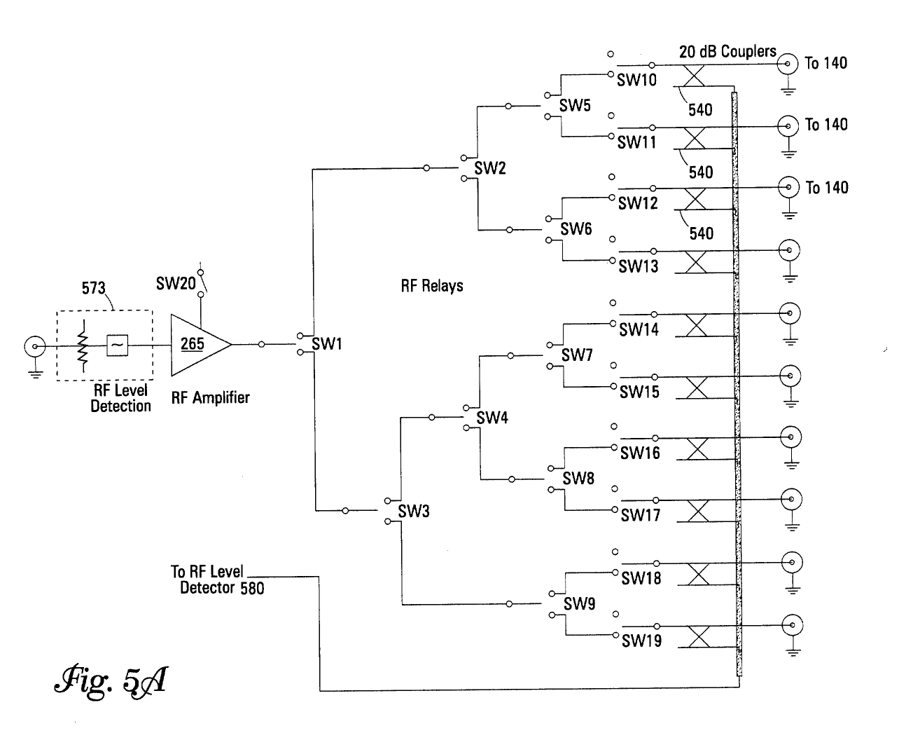

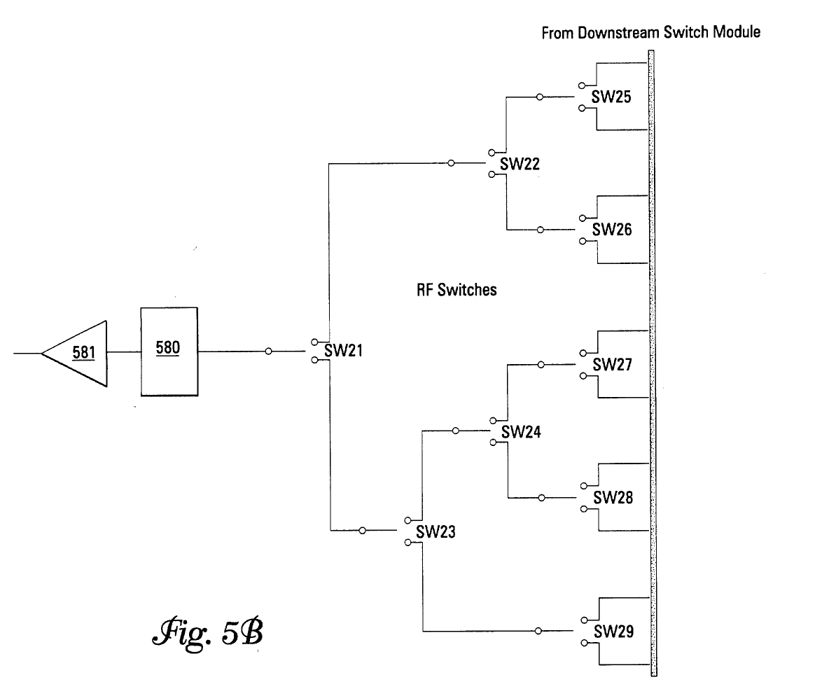

FIGS. 5A-5B are schematics of a downstream switch module 264 including optional directional couplers 540 and RF level detector 580 for use in testing all components in the signal path starting at the transmit portion of the Backup CMTS transceiver 130 and ending with the RF level detector 473 in the upstream switch module 262. The downstream switch module 264 may further include circuitry 573 for detecting the RF level of the backup signal path. Such can be used to assure that the RF level is within operating limits when the intended switches are activated. The RF level detector 580 may be used to adjust the gain of the amplifier 265 in order to provide near unity gain in the backup signal path. For one embodiment, the directional couplers 540 are 20 dB couplers.

The downstream switching module 264 includes a plurality of switches SW1-SW19 of FIG. 5A for selectively connecting a downstream communication port of the backup CMTS transceiver 130 to its associated directional coupler 140 through a directional coupler 540. An additional port of each directional coupler 540 is selectively connected to RF level detector 580, such as through switches SW21-SW29 of FIG. 5B. The unconnected port of each directional coupler 540 is preferably resistance terminated. An additional amplifier 581 may be connected to the RF level detector 580 for use in bringing the signal power to a desired level.

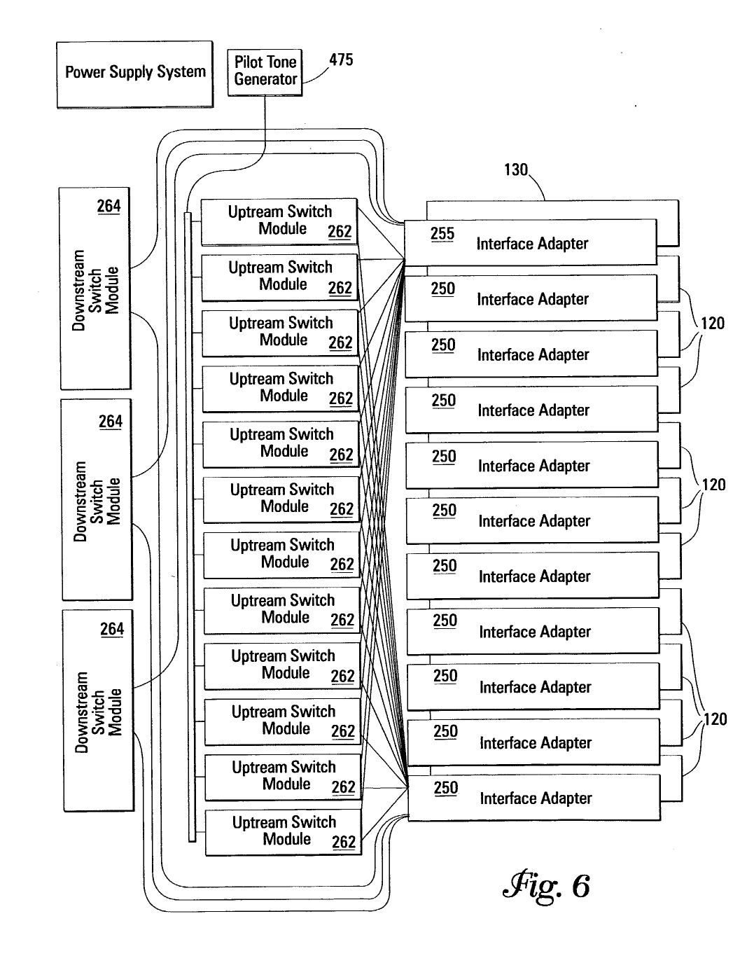

FIG. 6 is a block diagram of a CMTS 110 showing connectivity of various components. For clarity, signal lines are shown only for the first primary CMTS transceiver 120 and for the backup CMTS transceiver 130. Identical signal lines may run from each primary CMTS transceiver 120 to the upstream switch modules 262 and the downstream switch modules 264. Note that the CMTS 110 of FIG. 6 is depicted as having ten primary CMTS transceivers 120 and one backup CMTS transceiver 130, with each CMTS transceiver having twelve upstream communication ports and three downstream communication ports.

In one embodiment, CMTS 110 includes a controller card 160, as shown in FIG. 1. Controller card 160 is adapted to perform methods of operating CMTS 110 in accordance with embodiments of the invention in response to machine-readable instructions. In another embodiment, these instructions are in the form of hardware and are hard coded as part of controller card 160, e.g., an application-specific integrated circuit (ASIC) chip. In other embodiments, the machine-readable instructions are in the form of firmware or software stored on a machine-usable media 170 associated with controller card 160 for retrieval by a processor on controller card 160. In another embodiment, machine-usable media 170 includes static or dynamic random access memory (SRAM or DRAM), read-only memory (ROM), electrically-erasable programmable ROM (EEPROM or flash memory), magnetic media and optical media, whether permanent or removable, or the like.

In some embodiments, each of primary CMTS transceivers 120₁to 120_{N} and backup CMTS transceiver 130 includes machine-readable instructions in the form of firmware or software stored on a machine-usable medium 180, as shown in FIG. 2, such as ROM, EEPROM, flash memory or the like. In other embodiments, controller card 160 communicates with machine-usable media 180.

### OPERATING MODES

In one embodiment, CMTS 110 operates in two basic operating modes: a normal mode and an “overflow” mode. In the normal mode, the primary CMTS transceivers 120₁ to 120_{N} carry signals between the head end 102 and subscribers 104. When operational failures are detected during normal mode, backup CMTS transceiver 130 is logically inserted in place of the failed primary CMTS transceiver 120. In this capacity, backup CMTS transceiver communicates signals between subscribers 104 and head end 102 in place of the failed primary CMTS transceiver 120. Thus, in normal mode, backup CMTS transceiver 130 is placed in standby and does not carry signals between the head end 102 and subscribers 104 absent a failure of one of the primary CMTS transceivers.

In the overflow mode, backup CMTS transceiver 130 is provisioned to carry signals between the head end 102 and subscribers 104 when any one of the primary CMTS transceivers experiences an “overflow condition.” The term “overflow condition” is defined below. In the overflow mode, backup CMTS transceiver 130 is used to provide additional bandwidth for any of the primary CMTS transceivers 120. When the primary CMTS transceivers 120 are operational, the processing capabilities of the backup CMTS transceiver are available to meet intermittent demand for bandwidth not addressable by the individual primary CMTS transceivers. Thus, when an overflow condition is detected, the primary CMTS transceiver 120 continues to carry traffic over its associated physical media, e.g., coaxial cable connections, on its assigned CMTS channel or channels. Further, the backup CMTS transceiver 130 carries the additional signals corresponding to the intermittent demand over the same physical media as the CMTS channels of the primary CMTS transceiver 120. The backup CMTS transceiver 130 uses, for example, a different CMTS channel than the associated primary CMTS transceiver 120.

In one embodiment, when a failure in a primary CMTS transceiver 120 occurs during an overflow condition, the CMTS returns to normal operation mode and the backup CMTS transceiver 130 ceases to carry the overflow signals and begins to carry traffic in place of the failed, primary CMTS transceiver.

### NORMAL OPERATING MODE

For one embodiment of the normal operating mode, communication signals are transferred bi-directionally respectively between downstream communications ports 254₁ to 254_{P} of each of interface adapters 250₁ to 125_{N} and downstream communications ports 124₁ to 124_{P} of each of primary CMTS transceivers 120₁ to 120_{N} through the directional couplers 140_{DN}. Communication signals are also transferred bi-directionally respectively between upstream communications ports 252₁, to 252ₙ of each of interface adapters 250₁ to 250_{N} and upstream communications ports 122₁ to 122ₙ of each of primary CMTS transceivers 120₁ to 120_{N} through the directional couplers 140_{UP}.

In one embodiment, controller card 160 monitors operation of each of primary CMTS transceivers 120₁ to 120_{N} via machine-usable media 180. When one of CMTS transceivers 120₁ to 120_{N} fails, controller card 160 logically removes the failed CMTS transceiver from operation and logically replaces it with backup CMTS transceiver 130. More specifically, controller card 160 prevents transfer of communication signals to and from the failed transceiver. Controller card 160 instructs switch module 260 to respectively connect each of upstream communications ports 132₁ to 132ₙ of backup CMTS transceiver 130 with the directional couplers 140_{UP} respectively connected to the upstream communications ports 122₁ to 122ₙ of the failed transceiver. This respectively connects each of upstream communications ports 132₁ to 132ₙ to each of upstream communications ports 252₁ to 252ₙ of the one of interface adapters 250₁ to 250_{N} associated with the failed transceiver.

Controller card 160 also instructs switch module 260 to respectively connect each of downstream communications ports 134₁ to 134_{P} of backup CMTS transceiver 130 with the directional couplers 140_{DN} respectively connected to the downstream communications ports 124₁ to 124_{P} of the failed transceiver. This respectively connects each of downstream communications ports 134₁ to 134_{P} to each of downstream communications ports 254₁ to 254_{P} of the one of interface adapters 250₁ to 250_{N} associated with the failed transceiver.

### OVERFLOW MODE

In one embodiment, CMTS 110 operates in an overflow mode which allows the backup CMTS transceiver 130 to carry signals when the backup CMTS transceiver 130 is not operating as a backup to a failed primary transceiver 120. In overflow mode, the backup CMTS transceiver 130 effectively increases the bandwidth of one of the primary CMTS transceivers 120 on an intermittent basis. The backup CMTS transceiver 130 carries signals on one or more additional CMTS channels between subscribers 104 and the head end 102 over a shared physical medium with the primary CMTS transceiver 120. Advantageously, this is accomplished on an as-needed basis to utilize the available capacity of the backup CMTS transceiver 130.

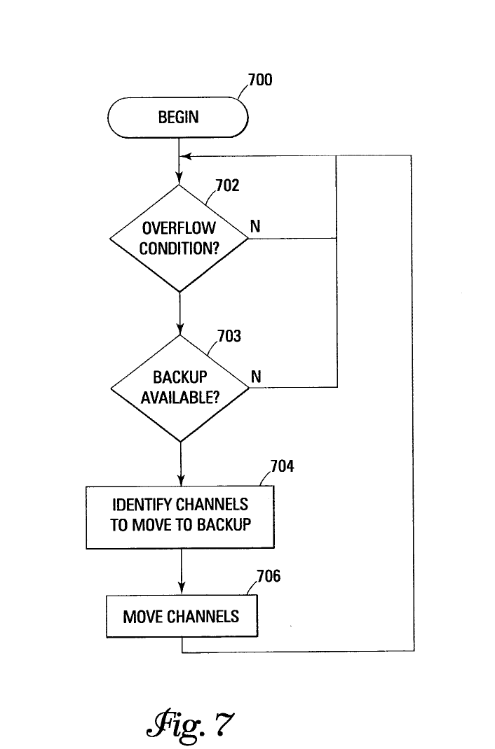

In overflow mode, controller card 160 monitors the flow of signals for each primary CMTS transceiver 120 to determine when additional capacity is needed or requested. This need or request for additional capacity is referred to as an “overflow condition.” In one embodiment, an overflow condition is determined by controller card 160. FIG. 7 provides one embodiment of a process for controller card 160 to operate in overflow mode. The process begins at block 700. At block 702, the process determines when an overflow condition exists. For example, in one embodiment, controller card 160 monitors the flow of signals at each of upstream communications ports 252₁ to 252ₙ and at each of downstream communications ports 254₁ to 254_{P} of each of interface adapters 250₁ to 250_{N} via machine-usable media 180. In one embodiment, additional bandwidth is needed for an overflow condition when the flow rate of communication signals at any of the upstream communication ports 252₁ to 252ₙ and/or at any of the downstream communication ports 254₁ to 254_{P} meets a selected criterion. In one embodiment, the selected criterion includes exceeding a particular flow rate of communication signals. In other embodiments, the selected criterion includes exceeding a particular flow rate of communication signals for a given period of time. In other embodiments, other selection criteria are used to determine an overflow condition. Essentially, an overflow condition is detected at block 702 based on any appropriate criteria or criterion indicating that backup CMTS transceiver 130 can be used to provide additional bandwidth.

In one embodiment, when an overflow condition is detected at block 702, controller card 160 determines whether the backup CMTS transceiver is available at block 703. For example, controller card 160 determines whether the backup CMTS transceiver is currently operating in place of a failed primary transceiver. If not, controller card 160 identifies CMTS channels for the primary CMTS transceiver to be rerouted to the backup CMTS transceiver at block 704. At block 706, the process issues commands to move the channels. In one embodiment, approximately one-third of the channels of a primary CMTS transceiver are moved to be handled by the backup CMTS transceiver. To implement this, in one embodiment, controller card 160 instructs switch module 260 to connect a corresponding upstream/downstream communications port 132/134 of backup CMTS transceiver 130 to the directional coupler 140_{UP}/140_{DN} connected to the upstream/downstream communications port 252/254. A first portion of communication signals, e.g., one or more CMTS channels, flows between the upstream/downstream communications port 122/124 and the corresponding upstream/downstream communications port 252/254 via the directional coupler 140_{UP}/140_{DN}, and a second portion of communication signals, e.g., one or more additional CMTS channels, flows between upstream upstream/downstream communications port 132/134 and the corresponding upstream/downstream communications port 252/254 via the directional coupler 140_{UP}/140_{DN}.

In one embodiment, controller card 160 switches from the overflow mode to the normal mode upon detecting that one of primary CMTS transceivers 120₁ to 120_{N} has failed. When this occurs, the subscribers using CMTS channels associated with the backup CMTS transceiver are redirected to channels associated with their respective primary CMTS tranceiver. Meanwhile, controller card 160 logically removes the failed CMTS transceiver from operation and replaces it with backup CMTS transceiver 130, as described above.

For another embodiment, controller card 160 switches from the overflow mode to the normal mode upon detecting that the one of CMTS transceivers 120₁ to 120_{N} having the overflow condition has failed. When this occurs, controller card 160 logically removes the failed CMTS transceiver from operation, as described above. The second portion of the communication signals is combined with the first portion, and the combined first and second portions flow between the upstream/downstream communications port 132/134 and the corresponding upstream/downstream communications port 252/254 via the corresponding directional coupler 140_{UP}/140_{DN}. The remaining upstream/downstream communications ports 132/134 of backup CMTS transceiver 130 are connected to the corresponding upstream/downstream communications ports 252/254 via the corresponding directional couplers 140_{UP}/140_{DN} to replace the corresponding upstream/downstream communications ports 122/124.

For another embodiment, controller card 160 switches from the overflow mode to the normal mode upon detecting that the overflow condition no longer occurs, e.g., when the flow rate of the communication signals no longer meets the selected criterion indicative of the overflow condition. When this occurs, the subscribers assigned to CMTS channels serviced by the backup CMTS transceiver are instructed to switch to a CMTS channel assigned to the primary CMTS transceiver and backup CMTS transceiver 130 is placed in a standby mode.

Cable modem termination systems (CMTS) have been described to facilitate redundancy without the need for active components, e.g., switches or amplifiers, in the primary signal path, and with a low signal loss in the primary signal path incurred by the redundancy components. Such elimination of active components in the primary signal path is made possible through the use of passive directional couplers in the primary signal path.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

What is claimed is:

1. A method for adjusting bandwidth allocation in a cable modem termination system, the method comprising:
detecting an overflow condition at a primary transceiver of the cable modem termination system;
determining whether a back-up transceiver is available in the cable modem termination system; and
when the back-up transceiver is available, establishing at least one channel for the back-up transceiver to communicate over a common physical medium with at least one channel of the primary transceiver to effectively increase the bandwidth of the cable modem termination system.

2. The method of claim 1, wherein detecting an overflow condition comprises detecting an intermittent need for additional bandwidth.

3. The method of claim 1, wherein detecting an overflow condition comprises monitoring flow rates at ports of the cable modem termination system.

4. The method of claim 3, wherein monitoring flow rates comprises monitoring flow rates to determine when a flow rate exceeds a selected flow rate.

5. The method of claim 1, and further identifying at least one channel serviced by the primary transceiver to move to the backup transceiver.

6. The method of claim 5, wherein identifying at least one channel comprises identifying at least one-third of the channels for moving to the backup transceiver.

7. A method for meeting intermittent increases in demand for bandwidth in a cable modem termination system having at least one primary transceiver and a back-up transceiver, the method comprising:
during a normal operation mode, communicating over at least one channel through a directional coupler and the at least one primary transceiver; and
during an overflow operation mode, communicating over at least one channel through a directional coupler and the at least one primary transceiver and over at least one additional channel through the directional coupler and the backup transceiver.

8. The method of claim 7, and further comprising returning to the normal mode when one of the at least one primary transceiver fails in overflow operation mode.

9. The method of claim 7, and further comprising communicating over at least one channel through a directional coupler and the backup transceiver when the at least one primary transceiver associated with the directional coupler fails.

10. The method of claim 7, and further comprising switching between normal and overflow operation modes when an overflow condition is detected.

11. The method of claim 7, and further comprising switching from overflow operation mode to normal operation mode when one of the at least one primary transceivers fails.

12. A method for increasing capacity of a cable modem termination system, the method comprising:
transferring communication signals between a directional coupler and a primary cable modem termination system transceiver during a normal operation mode; and
transferring communication signals between the directional coupler and the primary cable modem termination system transceiver and between the directional coupler and a backup cable modem termination system transceiver during an overflow operation mode.

13. The method of claim 12, further comprising entering the overflow operation mode when an overflow condition is detected.

14. A method of operating a cable modem termination system, the method comprising:
transferring communication signals between at least one port of at least one primary cable modem termination system transceiver and at least one port of a directional coupler during a normal operation mode, wherein the at least one directional coupler is connected between the at least one port and a head end or subscriber equipment;
detecting a data overflow condition between the at least one directional coupler and the head end or subscriber equipment; and
entering an overflow mode of operation comprising transferring a first portion of communication signals between the at least one port of the primary cable modem termination system transceiver and the at least one directional coupler and transferring a second portion of communication signals between at least one port of a backup cable modem termination system transceiver and the at least one directional coupler.

15. The method of claim 14, further comprising amplifying the second portion of the communication signals.

16. The method of claim 14, further comprising amplifying the second portion of the communication signals to compensate for losses through the directional coupler to create communication signals with near unity gain.

17. The method of claim 16, further comprising:
detecting a level of the second portion of communication signals; and
adjusting the amplification based on the detected level to create the communication signals with near unity gain.

18. The method of claim 14, further comprising monitoring the transfer of the communication signals between the at least one directional coupler and the head end or subscriber equipment.

19. The method of claim 14, further comprising returning to the normal operation mode upon detecting that the overflow condition no longer occurs.

20. The method of claim 11, further comprising returning to the normal mode of operation upon detecting a failure of the at least one primary transceiver, comprising transferring the first and second portions of communication signals between the at least one port of the backup transceiver and the at least one directional coupler.

21. A machine-readable medium comprising machine-readable instructions for causing a cable modem termination system to perform a method of increasing capacity of the cable modem termination system, the method comprising:
transferring communication signals between a directional coupler and a primary cable modem termination system transceiver during a normal operation mode; and
transferring communication signals between the directional coupler and the primary cable modem termination system transceiver and between the directional coupler and a backup cable modem termination system transceiver during an overflow operation mode.

22. The machine readable medium of claim 21, further comprising entering the overflow operation mode when an overflow condition is detected.

23. A machine-readable medium comprising machine-readable instructions for causing a cable modem termination system to perform a method for adjusting bandwidth allocation in a cable modem termination system, the method comprising:
detecting an overflow condition at a primary transceiver of the cable modem termination system;
determining whether a back-up transceiver is available in the cable modem termination system; and
when the back-up transceiver is available, establishing at least one channel for the back-up transceiver to communicate over a common physical medium with at least one channel of the primary transceiver to effectively increase the bandwidth of the cable modem termination system.

24. The machine-readable medium of claim 23, wherein detecting an overflow condition comprises detecting an intermittent need for additional bandwidth.

25. The machine-readable medium of claim 23, wherein detecting an overflow condition comprises monitoring flow rates at ports of the cable modem termination system.

26. The machine-readable medium of claim 25, wherein monitoring flow rates comprises monitoring flow rates to determine when a flow rate exceeds a selected flow rate.

27. The machine-readable medium of claim 23, and further identifying at least one channel serviced by the primary transceiver to move to the backup transceiver.

28. The machine-readable medium of claim 27, wherein identifying at least one channel comprises identifying at least one-third of the channels for moving to the backup transceiver.

29. A machine-readable medium comprising machine-readable instructions for causing a cable modem termination system to perform a method of operating the cable modem termination system, the method comprising:
transferring communication signals between at least one port of at least one primary cable modem termination system transceiver and at least one port of a directional coupler during a normal operation mode, wherein the at least one directional coupler is connected between the at least one port and a head end or subscriber equipment;
detecting a data overflow condition between the at least one directional coupler and the head end or subscriber equipment; and
entering an overflow mode of operation comprising transferring a first portion of communication signals between the at least one port of the primary cable modem termination system transceiver and the at least one directional coupler and transferring a second portion of communication signals between at least one port of a backup cable modem termination system transceiver and the at least one directional coupler.

30. The method of claim 29, further comprising monitoring the data transfer of the communication signals between the at least one directional coupler and the head end or subscriber equipment.

31. The method of claim 29, further comprising returning to the normal operation mode upon detecting that the overflow condition no longer occurs.

32. The method of claim 29, further comprising returning to the normal mode of operation upon detecting a failure of the at least one primary transceiver, the normal mode of operation comprising transferring the first and second portions of the communication signals between the at least one port of the backup cable modem termination system transceiver and the at least one directional coupler.

33. A cable modem termination system, comprising:
at least one primary cable modem termination system transceiver;
at least one directional coupler connected to the primary cable modem termination system transceiver through a primary signal path;
one backup cable modem termination system transceiver selectively connected to the at least one directional coupler through a secondary signal path outside of the primary signal path; and
a machine-readable medium comprising machine-readable instructions for causing the at least one primary cable modem termination system transceiver to transceive communication signals through the primary signal path during a normal operating mode and for causing the at least one primary cable modem termination system transceiver to transceive a first portion of communication signals through the primary signal path and the one backup cable modem termination system transceiver to transceive a second portion of communication signals through the secondary signal path during an overflow operating mode.

34. The cable modem termination system of claim 33, further comprising at least one switch module connected between the backup cable modem termination system transceiver and the at least one primary cable modem termination system transceiver for selectively connecting the backup cable modem termination system transceiver to the at least one directional coupler.

35. The cable modem termination system of claim 34, wherein the at least one switch module further comprises an amplifier connected between the one backup cable modem termination system transceiver and the at least one primary cable modem termination system transceiver.

36. The cable modem termination system of claim 34, wherein the at least one switch module further comprises RF level correction circuitry.

37. A cable modem termination system comprising:
at least two primary cable modem termination system transceivers;
a plurality of directional couplers connected to each of the at least two primary cable modem termination system transceivers through a primary signal path;
one backup CMTS transceiver selectively connected to the plurality of directional couplers through a secondary signal path outside of the primary signal path; and
a machine-readable medium comprising machine-readable instructions for causing the at least two primary cable modem termination system transceivers to transceive communication signals through the primary signal path during a normal operating mode and for causing one or both of the at least two primary cable modem termination system transceivers to transceive a first portion of communication signals through the primary signal path and the one backup cable modem termination system transceiver to transceive a second portion of communication signals through the secondary signal path during an overflow operating mode.

38. The cable modem termination system of claim 37, further comprising a switch module connected between the backup cable modem termination system transceiver and the at least two primary cable modem termination system transceivers for selectively connecting the backup cable modem termination system transceiver to the plurality of directional couplers.

39. The cable modem termination system of claim 38, wherein the backup and the at least two primary cable modem termination system transceivers each further comprise one or more upstream communication ports and one or more downstream communication ports, wherein each communication port of each of the at least two primary cable modem termination system transceivers is connected to one of the plurality of directional couplers, wherein the switch module further comprises an upstream switch module associated with each upstream communication port of the backup cable modem termination system transceiver for selectively connecting that upstream communication port to a directional coupler associated with a corresponding upstream communication port of one of the at least two primary cable modem termination system transceivers, and wherein the switch module further comprises a downstream switch module associated with each downstream communication port of the backup cable modem termination system transceiver for selectively connecting that downstream communication port to a directional coupler associated with a corresponding downstream communication port of one of the at least two primary cable modem termination system transceivers.

40. The cable modem termination system of claim 39, wherein each switch module further comprises an amplifier connected between its associated communication port of the backup cable modem termination system transceiver and the associated communication ports of the at least two primary cable modem termination system transceivers.

41. The cable modem termination system of claim 38, wherein each switch module further comprises RF level correction circuitry.

42. An overflow system for a cable modem termination system, comprising:
a first directional coupler comprising a first port for connecting to a communication line, a second port connected to a primary cable modem termination system transceiver, and a third port selectively connected to a backup cable modem termination system transceiver; and
a machine-readable medium comprising machine-readable instructions for causing the primary cable modem termination system transceiver to transceive communications on the communication line in a normal operation mode and the primary cable modem termination system transceiver to transceive a first portion of communications on the communication line and the backup cable modem termination system transceiver to transceive a second portion of communications on the communication line in an overflow operation mode.

43. The overflow system of claim 42, further comprising a switch module connected between the backup cable modem termination system transceiver and the first directional coupler for selectively connecting the backup cable modem termination system transceiver to the third port of the first directional coupler or to a third port of another first directional coupler connected to another primary cable modem termination system transceiver.

44. A cable modem termination system, comprising:
at least one primary cable modem termination system transceiver comprising one or more upstream communication ports for communication with subscriber equipment and one or more downstream communication ports for communication with a head end;
at least one backup cable modem termination system transceiver comprising one or more upstream communication ports for communication with the subscriber equipment and one or more downstream communication ports for communication with the head end; and
a plurality of directional couplers, with a directional coupler connected to each communication port of the at least one primary cable modem termination system transceiver through a first signal path;
wherein each communication port of the at least one backup cable modem termination system transceiver is selectively connected to a directional coupler of a corresponding communication port of the at least one primary cable modem termination system transceiver through a second signal path; and
a machine-readable medium comprising machine-readable instructions for causing the at least one primary cable modem termination system transceiver to transceive communication signals through the primary signal path during a normal operating mode and for causing the at least one primary cable modem termination system transceiver to transceive a first portion of communication signals through the first signal path and the one backup cable modem termination system transceiver to transceive a second portion of communication signals through the second signal path during an overflow operating mode.

45. The cable modem termination system of claim 81, further comprising a switch module connected between the at least one backup cable modem termination system transceiver and the at least one primary cable modem termination system transceivers for selectively connecting the at least one backup cable modem termination system transceiver to the plurality of directional couplers.
